(19) United States
(12) Patent Application Publication
(10) Pub. No.: US 2012/0001559 A1
(43) Pub. Date: Jan. 5, 2012

(54) LED ARRAY DRIVER

(76) Inventor: Laurence Aubrey Tunnicliffe, Victoria (AU)

(21) Appl. No.: 13/144,007

(22) PCT Filed: Jan. 12, 2010
(86) PCT No.: PCT/AU2010/000021

§ 371 Date: Sep. 22, 2011

(30) Foreign Application Priority Data
Jan. 12, 2009 (AU) 2009900089

(51) Int. Cl. H05B 37/02

(52) U.S. Cl. 315/201; 315/210

(57) ABSTRACT

An LED driver (10) for driving an array of LEDs (22, 24, 26) from an AC power supply (14) including a plurality of switches (16, 18, 20), each switch acting to selectively enable forward conduction of a different LED (22, 24, 26); and a switch control unit (28) for controlling operation of the plurality of switches (16, 18, 20) so as to switch different, non-overlapping phase angle portions of a same repetitive waveform through each LED (22, 24, 26).

The present invention relates generally to a driver for driving an array of LEDs from an AC power source, and in particular to drivers which enable individual control of LEDs within the array. The present invention is suitable for use in arrays including red, green and blue LEDs and in which individual LEDs are controlled in order to achieve a desired colour mix in the light emitted by the LED array, and it will be convenient to describe the invention in relation to that is exemplary application. It will be appreciated however, that the invention is not limited to use in this exemplary application only.

It is well known that combining the three primary colours, red, green and blue of projected light in different ratios will produce almost any colour of emitted light. In addition, it is known that delivering varying amounts of energy to illuminating devices, such as light emitting diodes or LEDs, will vary the perceived brightness of the illuminating device. Existing colour mixing circuits use these principles to provide a cross blend from one solid colour to another of light emitted from an array of LEDs, as well as to control the brightness of each colour.

Prior LED control circuits have used a DC power supply requiring filtering components and regulating components to stabilise the DC level. In addition, these types of power supplies require additional energy storage components and typically have poor power factors. In multi coloured systems, a current regulating circuit is usually reproduced two or more times in order to control each component of the system. Pulse-width modulation is a common means of controlling the energy delivered to LEDs in such an array, however that pulse-width modulation requires additional energy storage components for correct circuit operation. In addition, such prior art control circuits may generate radio frequency emissions that require additional components for suppression to levels that are suitable for domestic use.

It would therefore be desirable to provide a means for driving an array of LEDs which ameliorate or overcome one or more problems of known LED drivers.

One aspect of the present invention provides an LED driver for driving an array of LEDs from an AC power supply, including a plurality of switches, each switch acting to selectively enable forward conduction of a different LED; and a switch control unit for controlling operation of the plurality of switches so as to switch different, non-overlapping phase angle portions of a same repetitive waveform through each LED.

The switch control unit may include a zero crossing detector for detecting zero crossing points in a repetitive waveform; and a switch activation unit for controlling phase angles from a detected zero crossing point at which each switch is operated.

In one or more embodiments, a current limiter may be connected between the AC power supply and the array of LEDs. For example, the current limiter may be a resistive element, an electronic circuit or form part of a step down transformer connecting to the AC power supply.

The array of LEDs may be enclosed in a housing. In this case, the current limiter may be provided externally to the housing.

The LED driver may further include a rectifier for rectifying an AC waveform in order to generate the repetitive waveform.

The zero crossing detector may monitor the repetitive waveform at the output of the rectifier.

One or more of the switches may be a MosFet, bipolar transistor or silicon controlled rectifier.

The array of LEDs may include at least two LEDs emitting different colours, the switch control unit controlling operation of the plurality of switches to achieve a desired mix of coloured light emitting from the at least two LEDs emitting different colours.

The switch control unit may be implemented in one or more embodiments as a microprocessor.

Another aspect of the invention provides a switch control unit forming part of an LED driver as described hereabove.

Various aspects and features of the invention will be more fully understood with reference to the drawings in which:

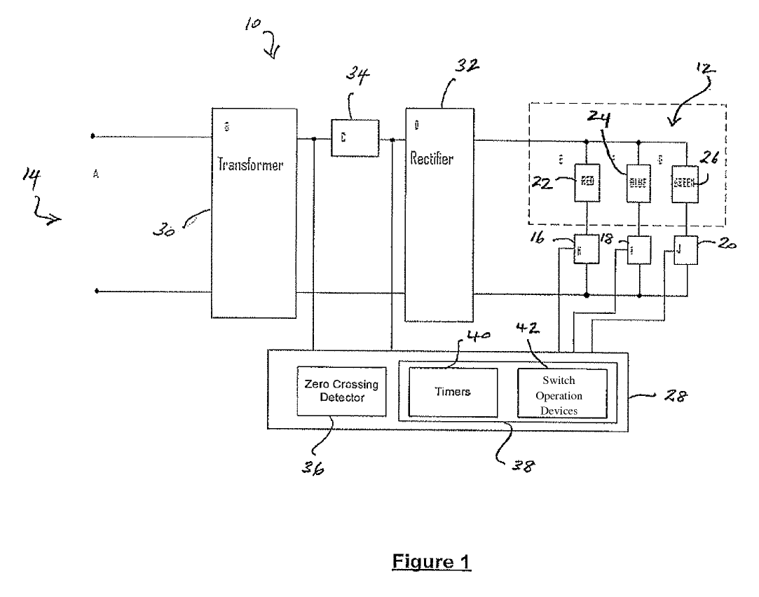

FIG. 1 is a schematic diagram of one embodiment of an LED driver for driving an array of LEDs from an AC power source; and

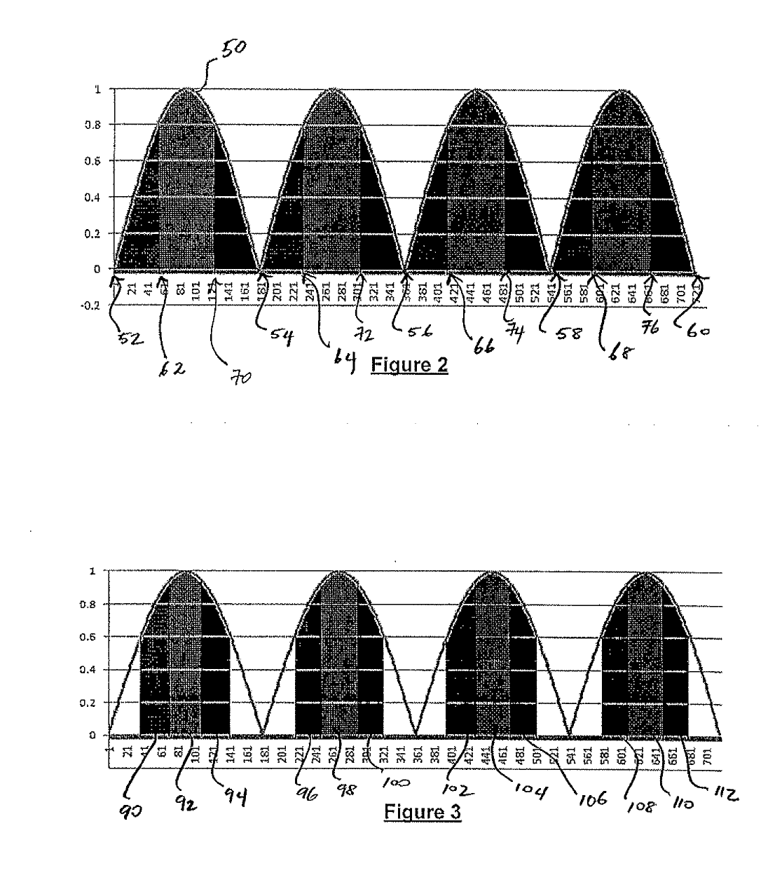

FIGS. 2 to 4 are graphical representations of different non-overlapping phase angle portions of a same repetitive waveform switched through the LEDs forming part of the array driven by the LED driver depicted in FIG. 1.

Referring out of FIG. 1, there is shown generally an LED driver 10 for driving an array of LEDs 12 from an AC power source 14. The driver 10 includes switches 16, 18 and 20 each one of which is connected in series with a corresponding LED, respectively referenced 22, 24 and 26. The switches 16, 18 and 20 act respectively to selectively enable forward conduction of the LEDs 22, 24 and 26. Operation of the switches 16, 18 and 20 is controlled by a switch control unit 28.

Conveniently, the switches may be implemented in the form of MosFet semi conductor devices which provide rapid switching times. However, in other embodiments of the invention the switches may be implemented by a bipolar transistor, silicon controlled rectifier or other suitable semi conductor or non semi conductor switching device.

Whilst the switches depicted in FIG. 1 are each connected in series with a corresponding LED, in other embodiments of the invention the switches may be connected in parallel with a corresponding LED. When connected in parallel with a corresponding LED, the closing of the switch provides a shunt connection across the LED and ensures no current flow therethrough, whereas the opening of the switch breaks the shunt connection and enables the forward conduction of currents through the LED.

In this embodiment, the LED driver includes a step down transformer 30 for controlling the voltage of the AC waveform generated from the AC power supply 14. The output of the transformer 30 is connected to a rectifier 32. The rectifier 32 may provide either full wave or half wave rectification to the AC waveform. An exemplary repetitive waveform 50 is depicted in FIG. 2 which has been generated by the full wave rectification of the AC waveform.

In the embodiment depicted in FIG. 1, a current limiter 34 is connected between the AC power supply 14 and the array 12 of LEDs. More particularly, in this example the current limiter 34 is connected between the transformer 30 and the rectifier 32. The current limiter may be a simple resistive element, or alternatively may be embodied by an electronic circuit or may form part of the step down transformer 30 via a matched winding resistance.

The switch control unit 28 includes a zero crossing detector 36 which monitors the repetitive wave form at the output of the rectifier 32. In addition, the switch control unit 28 includes a switch activation unit 38 including one or more timers 40 and switch operation devices 42. In use, the switch control unit 28 controls operation of the switches 22 to 26 so as to switch different, non-overlapping phase angle portions of the same repetitive waveform 50 through each LED. In this way, the amount of energy delivered to each colour component can be varied whilst maintaining a constant overall power delivered to the LED array 12 and drawn from the AC power supply 14.

When the current limiter is a resistive element, the LED driver 10 draws current from the AC power supply 14 that is always in phase with the voltage, thereby resulting in a unit power factor. Moreover, in the arrangement depicted in FIG. 1, the repetitive waveform 50 is substantially sinusoidal, thus eliminating most or all switching artefacts which would otherwise cause RF transmission during operation of the LED driver 10.

The zero crossing detector 36 monitors voltage at the output of the rectifier, and detects the zero crossing points, such as those referenced 52 to 60 in FIG. 2 in the repetitive waveform 50. From this datum, the timers 40 determine switch-on and switch-off times for each LED corresponding to the phase angles from the detected zero crossing point at which each of the switches 16 to 20 are desired to be operated in order to achieve a predetermined colour mix.

In the example depicted in FIG. 2, the switch 16 may be caused to close by the switch operation devices 42 at the zero crossing points 52 to 60, and may be caused to close at predetermined times 62 to 68 thereafter. When the switch 16 closes at instance 62 to 68, the switch activation unit 38 acts to open switch 18 to enable forward conduction of the LED 24 from instance 62 to 68 until instance 70 to 76, at which time the switch 18 opens. Finally, when the switch 18 opens, the switch activation unit 38 causes the switch 20 to close, thereby enabling the LED 26 to forward conduct from instants 70 to 76 until instants 54 to 60.

From the foregoing, it will be appreciated that different non-overlapping phase angle portions of the same repetitive waveform 50 are switched to each of the LEDs 22 to 26 by the LED driver 10.

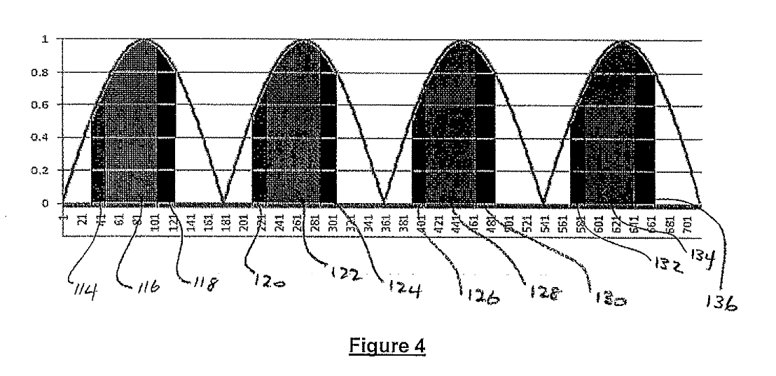

By controlling the instants between which each of the LEDs 22 to 26 are able to forward conduct, it is possible for the switch control unit 28 to control the amount of energy delivered to each LED so as to achieve a desired mix of coloured light emitted from the LEDs 22 to 26. FIGS. 3 and 4 show two such examples in which the duration and temporal position of the phase angle portions 90 to 136 are varied so as to achieve a desired colour mix.

It will be appreciated that the switch control unit 28 may be implemented in the form of a microprocessor. The microprocessor may include a series of instructions to enable desired operation of the LED driver 10 to be implemented.

Whilst the present invention has been described in conjunction with a limited number of embodiments, it will be apparent to those skilled in the art that many alternatives, modifications and variations are possible in light of the foregoing description. Accordingly, the present invention is intended to embrace all such alternatives, modifications and variations as may forward in the spirit and scope of the invention as disclosed.

1. An LED driver for driving an array of LEDs from an AC power supply, including:
a plurality of switches, each switch acting to selectively enable forward conduction of a different LED; and
a switch control unit for controlling operation of the plurality of switches so as to switch different, non-overlapping phase angle portions of a same repetitive waveform through each LED.

2. An LED driver according to claim 1, wherein the switch control unit includes:
a zero crossing detector for detecting zero crossing points in the repetitive waveform; and
a switch activation unit for operating each switch at controlled phase angles from a detected zero crossing point.

3. An LED driver according to claim 2, and further including:
a current limiter connected between the AC power supply and the array of LEDs.

4. An LED driver according to claim 3, wherein the current limiter is a resistive element.

5. An LED driver according to claim 3, wherein the current limiter is an electronic circuit.

6. An LED driver according to claim 3, wherein the current limiter forms part of a step-down transformer connected to the AC power supply.

7. An LED driver according to claim 3, and further including a housing enclosing the LEDs, wherein the current limiter is external to the housing.

8. An LED driver according to claim 1, and further including a rectifier for rectifying an AC waveform in order to generate the repetitive waveform.

9. An LED driver according to claim 8 when dependant upon claim 2, wherein the zero crossing detector monitors the repetitive waveform at the output of the rectifier.

10. An LED driver according to claim 1, wherein one or more switches are a MosFet, a bipolar transistor or silicon controlled rectifier.

11. An LED driver according to claim 5, wherein the array of LEDs includes at least two LEDs emitting different colours, the switch control unit controlling operation of the plurality of switches to achieve a desired mix of coloured light emitted from the at least two LEDs emitting different colours.

12. An LED driver according to claim 1, wherein the switch control unit is implemented as a microprocessor.

13. A switch control unit forming part of an LED driver according to claim 1.
